(19) United States
(12) Patent Application Publication
(10) Pub. No.: US 2023/0097185 A1
(43) Pub. Date: Mar. 30, 2023

(54) PRECISION OPTICAL CHAMBER DEVICE, SYSTEM, AND METHOD OF MANUFACTURING SAME

(71) Applicant: RELAY MEDICAL CORP., Etobioke (CA)

(72) Inventors: Andrzej MACZUSZENKO, Toronto (CA); Jake HOLLOWAY, Toronto (CA); Tomasz GLAWDEL, Toronto (CA)

(21) Appl. No.: 17/799,431

(22) PCT Filed: Feb. 12, 2021
(86) PCT No.: PCT/CA2021/050151

§ 371 Date: Aug. 12, 2022

Related U.S. Application Data
(60) Provisional application No. 62/975,750, filed on Feb. 12, 2020.

(51) Int. Cl. G01N 21/03; G01N 21/31; B01L 3/00

(52) U.S. Cl. CPC G01N 21/0303; G01N 21/31; B01L 3/502715; B01L 2300/168; B01L 2300/0654; B01L 2200/04; B01L 2200/027; B01L 2400/0478; B01L 2300/0877

(57) ABSTRACT

Spectrophotometric measurements on highly absorbing turbid samples face technical challenges that can be solved by reducing a path length of an optical chamber used during measurement. Reducing the path length requires exceptional control of variables that may be difficult to achieve in unit-use and inexpensive cuvettes. The invention provides a precise inexpensive method for producing an optical cavity useful in making spectrophotometric measurements on high attenuation liquid samples. Two components are shaped such that, when in contact, a central optical chamber and peripheral groove are formed. Liquid adhesive dispensed into the groove wicks around the interface perimeter, sealing the components together when cured. This results in a short precisely controlled path length that reduces chances of mechanical induced distortions (that arise with other bonding methods). The invention provides for manufacturing of a consistent optical chamber with very short path length within a diagnostic cartridge or cuvette.

### FIELD OF THE INVENTION

The present invention relates generally to a method or producing an optical cavity and, more specifically, to a precision optical chamber device, system, and method of manufacturing same.

The present invention relates to an improved method of producing an optical cavity, preferably enabling a spectrophotometric measurement to be performed on high attenuation liquid samples including turbid samples. Spectrophotometry may be generally understood to be a method for determining the chemical composition of a substance by exposing a sample of that substance to a light source and measuring the absorption and/or emission of light as a function of wavelength after interacting with the sample. In medicine, spectrophotometry can be used to detect concentrations of specific molecules within a sample of whole blood, including for example, the various forms of hemoglobin and bilirubin.

### BACKGROUND OF THE INVENTION

The present invention relates to a method for producing either a unit-use cuvette or a cuvette module to be incorporated into a more complex unit-use diagnostic cartridge, enabling improved accuracy and reduced cost in making a spectrophotometric measurement on high attenuation liquid samples. Such samples may preferably include those with high concentration of absorbing molecules, and/or turbid samples with substantial scattering properties. Turbid samples—which may be defined as those appearing cloudy and/or hazy, perhaps at least in part due to large amounts of suspended matter in a fluid—may present many challenges to the spectrophotometric method. In whole blood specifically, the red blood cells suspended in the plasma may both absorb and scatter light so effectively that the attenuated light intensity reaching the detector may become very low, yielding a low signal to noise ratio, and/or reducing accuracy of the measurement.

Selecting a more sensitive photodetector, which may accommodate the low light intensity, may also come at a substantially higher cost. One can also apply schemes to remove the scattering effect of red blood cells by lysis, but this may come with technical challenges and potentially therefore increased cost. A third solution may be to greatly reduce the thickness of the optical path length to within the approximate range of 80-120 micrometers. The optical path length may be defined as the nominal distance that light travels through the sample from the light source to the optical detector, and the amount of light absorbed may be directly proportional to the optical path length. This distance may be short enough to bring the total attenuation of the whole blood within the dynamic range of the detector system. However, this method may come with its own challenges, for example, variability in the path length may induce significant errors in the calculated concentrations according to the Lambert-Beer Law. Minimizing the ratio of path length variation to path length in a 100-micron path length, unit-use and, potentially therefore, inexpensive cuvette may not be trivial, and existing solutions may appear to fall short.

One such prior art method for producing such a cuvette may have involved ultra-sonically welding two injection moulding components together to form the optical chamber. However, it appears, there may have been limitations in this process, which limited the path length to greater than or equal to 180 micrometers, which may have been longer than ideal. Another prior art solution may have bonded two flat plates together with a middle layer, made of die-cut double-sided tape, that when sandwiched may have formed a cavity the thickness of the tape. With this method, there may have been multiple sources of error in the path length, such as variation in the thickness of the tape, the existence of wrinkles or air bubbles between the tape and the plates, unit to unit variation in the lamination pressure, and/or distortion of the optical surfaces and/or optical cavity, perhaps due at least in part to spatial variation in lamination pressure. This method may have been difficult and, potentially therefore, costly to scale, perhaps at least in part since there may have been many process parameters that required tight control.

This review of the technical challenges and/or inadequacy of existing solutions may indicate that a new, inexpensive method for producing an optical cavity with short and/or precise path length may be very useful in improving the field of spectrophotometry on high attenuating liquid samples including turbid media.

It may be an object according to one aspect of the invention to provide a precision optical chambers device, system, and/or method of manufacturing same.

It is an object of the present invention to obviate or mitigate one or more disadvantages and/or shortcomings associated with the prior art, to meet or provide for one or more needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

According to the invention, there is disclosed a method of manufacturing an optical chamber device. The device is for receiving a fluid sample and for use with an optical diagnostic device. The method includes a step of forming a transparent top plate with a bottom surface having an inner portion and an outer portion. In this step, the top plate is also formed with a downward-facing lip member that is inset from the outer portion and extends downwardly from the bottom surface by a precise depth. As such, the inner portion is circumscribed by the downward-facing lip member. The method also includes a step of forming a transparent bottom plate with a top surface. The method includes a further step of placing the top plate on the bottom plate, with the downward-facing lip member engaging the top surface. In this manner, an optical cavity is formed between the top surface and the inner portion on the bottom surface, with the optical cavity bounded by the downward-facing lip member. The precise depth defines an optical path length for the optical cavity. An open groove is formed between the top surface and the outer portion on the bottom surface, with the open groove extending about a perimeter of the downward-facing lip member. The method also includes a step of dispensing a liquid adhesive into the open groove, such that the liquid adhesive wicks around the perimeter by capillary action and fills the open groove. The method includes a further step of curing the liquid adhesive to bond the top plate together with the bottom plate, and to seal the optical cavity around the perimeter. Whereby, the optical path length of the optical cavity (that receives the liquid sample in use) is precisely controlled so that the optical diagnostic device can selectively perform precise optical measurements on the liquid sample in use.

According to an aspect of one preferred embodiment, the top plate is formed by injection moulding.

According to an aspect of one preferred embodiment, the bottom plate is formed, by injection moulding, with an upward-facing peripheral lip member that extends upwardly from the top surface. When the top plate is placed on the bottom plate, the top plate is placed within the upward-facing peripheral lip member on the top surface. When an excess of the liquid adhesive is dispensed into the open groove, the upward-facing peripheral lip member contains the excess.

According to an aspect of one preferred embodiment, the transparent top plate and the transparent bottom plate are formed from an optically transparent material that is appropriate for the precise optical measurements and the optical diagnostic device. The optically transparent material is selected from the group consisting of ultraviolet transparent materials, one or more color transparent materials, and infrared transparent materials.

According to an aspect of one preferred embodiment, the bottom plate is integrally formed as part of a cartridge. In use, the cartridge receives the liquid sample and fills the optical cavity with the liquid sample, enabling the optical diagnostic device to selectively perform the precise optical measurements on the liquid sample.

According to an aspect of one preferred embodiment, the method also includes a step of bonding the top plate and/or the bottom plate to a cartridge frame. In use, the cartridge frame receives the liquid sample and fills the optical cavity with the liquid sample, enabling the optical diagnostic device to selectively perform the precise optical measurements on the liquid sample.

According to the invention, there is also disclosed an optical chamber device that is manufactured according to one or more of the above methods.

According to the invention, there is also disclosed an optical chamber device for receiving a fluid sample and for use with an optical diagnostic device. The device includes a transparent top plate and a transparent bottom plate. The bottom plate has a top surface. The top plate has a bottom surface with an inner portion and an outer portion. The top plate also has a downward-facing lip member that is inset from the outer portion and extends downwardly from the bottom surface by a precise depth. As such, the inner portion is circumscribed by the downward-facing lip member. The downward-facing lip member engages the top surface. An optical cavity is formed between the top surface and the inner portion on the bottom surface. The optical cavity is bounded by the downward-facing lip member, such that the precise depth defines an optical path length for the optical cavity. An open groove is formed between the top surface and the outer portion on the bottom surface, with the open groove extending about a perimeter of the downward-facing lip member. A cured liquid adhesive fills the open groove and bonds the top plate together with the transparent bottom plate, and seals the optical cavity around the perimeter. Whereby, the optical path length of the optical cavity (that receives the liquid sample in use) is precisely predetermined so that the optical diagnostic device can selectively perform precise optical measurements on the liquid sample in use.

According to an aspect of one preferred embodiment, the bottom plate has an upward-facing peripheral lip member that extends upwardly from the top surface. The top plate is positioned within the upward-facing peripheral lip member on the top surface. The upward-facing peripheral lip member contains any excess of the cured liquid adhesive that is dispensed into the open groove.

According to an aspect of one preferred embodiment, the transparent top plate and the transparent bottom plate are constructed from an optically transparent material that is appropriate for the precise optical measurements and the optical diagnostic device. The optically transparent material is selected from the group consisting of ultraviolet transparent materials, one or more color transparent materials, and infrared transparent materials.

According to an aspect of one preferred embodiment, the device includes a cartridge. In use, the cartridge receives the liquid sample and fills the optical cavity with the liquid sample, so that the optical diagnostic device can selectively perform the precise optical measurements on the liquid sample. The bottom plate is integrally formed with the cartridge.

According to an aspect of one preferred embodiment, the device includes a cartridge frame. In use, the cartridge frame receives the liquid sample and fills the optical cavity with the liquid sample, so that the optical diagnostic device can selectively perform the precise optical measurements on the liquid sample. The top plate and/or the bottom plate are bonded to the cartridge frame.

According to the invention, there is also disclosed a precision optical chamber device, system, and/or a method of manufacturing same. The device, system, and/or method may preferably define and/or produce a precise and/or inexpensive optical cavity. The optical cavity is preferably defined, at least in part, by a first transparent plate-like component. This plate-like component may be alternately referred to herein as a “top plate”. The top plate is preferably provided with a lip, on a bottom surface of the top plate, that is offset from the perimeter. As such, when placed on a second transparent plate-like component (alternately referred to herein as a “bottom plate”), the cavity is preferably formed between the two plates, which is bounded by the lip and whose depth, defined by the height of the lip, now defines the path length of a spectrophotometric measurement to be performed. A groove is preferably formed by the two mating components around the lip's perimeter. As such, when liquid adhesive is dispensed into the groove, the adhesive will preferably wick around the perimeter, preferably by capillary action. Preferably, when cured, the adhesive bonds the two components together, sealing the optical cavity around its perimeter.

According to an aspect of one preferred embodiment, the top plate may preferably, but need not necessarily, be formed by a method of injection moulding.

According to an aspect of one preferred embodiment, the bottom plate may preferably, but need not necessarily, be formed by a method of injection moulding. The bottom plate may preferably, but need not necessarily, feature an upward facing lip. The top plate may preferably, but need not necessarily, fit within the upward facing lip, preferably to contain excess adhesive that may be dispensed during assembly.

According to an aspect of one preferred embodiment, the bottom plate itself may preferably, but need not necessarily, be a diagnostic cartridge. The bottom plate may preferably, but need not necessarily, allow a liquid sample to fill the optical cavity, preferably to perform a spectrophotometric measurement.

According to an aspect of one preferred embodiment, the sub-assembly made of the top plate and/or the bottom plate may preferably, but need not necessarily, be bonded to a diagnostic cartridge and/or to any other component which may preferably allow a liquid sample to fill the optical cavity, preferably to perform a spectrophotometric measurement.

According to the invention, it may become apparent from this review that the problems associated with making a spectrophotometric measurement on high attenuating liquid samples including turbid media may not have been adequately solved by the prior art. A method to produce a single-use cuvette with a short, precise path length may be very useful to the field of spectrophotometry.

The present invention may preferably provide a precise and/or inexpensive method for producing a short optical path length chamber with which to hold a liquid sample, preferably for the purposes of making a spectrophotometric measurement. Two components may preferably, but need not necessarily, be shaped such that when placed in contact, a central cavity and/or a peripheral groove may be formed, such that when liquid adhesive is dispensed into the groove, it may preferably, but need not necessarily, wick around the interface perimeter, preferably sealing the components together when cured. This may preferably, but need not necessarily, result in a short and/or precisely controlled path length, perhaps due at least in part to the repeatability of the injection moulding process and/or to the elimination of bonding induced distortions of the cavity.

Other advantages, features and characteristics of the present invention, as well as methods of operation and manufacture, and functions of the related elements of the structure, and the combination of parts and economies of manufacture, will become more apparent upon consideration of the following detailed description with reference to the figures which accompany this application.

### BRIEF DESCRIPTION OF THE DRAWINGS

The novel features which are believed to be characteristic of the present invention, and related devices, systems, and methods according to the present invention, as to their structure, organization, use and method of operation and manufacture, together with further objectives and advantages thereof, may be better understood from the figures which accompany this application, in which presently preferred embodiments of the invention are illustrated by way of example. It is expressly understood, however, that such figures are for the purpose of illustration and description only, and not intended as a definition of the limits of the invention. In the accompanying drawings:

FIG. 1A is a top view of an optical chamber device according to a preferred embodiment of the invention;

FIG. 1B is a sectional view of the device of FIG. 1A, along sight line 1B-1B thereof;

FIG. 1C is a close-up detailed view on encircled portion 1C of FIG. 1B;

FIG. 2A is a bottom view of a top plate of the device of FIG. 1A;

FIG. 2B is a sectional view of the top plate of FIG. 2A, along sight line 2B-2B thereof;

FIG. 2C is a close-up detailed view on encircled portion 2C of FIG. 2B;

FIG. 3A is a top view of a bottom plate of the device of FIG. 1A;

FIG. 3B is a sectional view of the bottom plate of FIG. 3A, along sight line 3B-3B thereof;

FIG. 4A is a top view of the device of FIG. 1A, showing an adhesive dispensed into a bond area between the top and bottom plates;

FIG. 4B is a top view similar to FIG. 4A, showing subsequent flow of the adhesive further into the bond area;

FIG. 4C is a top view similar to FIG. 4B, showing subsequent flow of the adhesive still further into the bond area;

FIG. 4D is a top view similar to FIG. 4C, showing the adhesive filling the bond area;

FIG. 5 is a flow chart depicting steps involved in manufacturing the optical chamber device of FIG. 1A;

FIG. 6 is an exploded top perspective view of another optical chamber device according to another preferred embodiment of the invention, showing an integral cartridge and bottom plate thereof;

FIG. 7 is an exploded top perspective view of a cartridge assembly according to another preferred embodiment of the invention, showing two optical chamber devices thereof;

FIG. 8 is a top perspective view of the optical chamber device of FIG. 6, shown in use with a syringe;

FIG. 9A is a top view of the device of FIG. 1A, showing a sample dispensed into a optical cavity thereof;

FIG. 9B is a top view similar to FIG. 9A, showing subsequent flow of the sample further into the optical cavity;

FIG. 9C is a top view similar to FIG. 9B, showing subsequent flow of the sample still further into the optical cavity;

FIG. 9D is a top view similar to FIG. 9C, showing the sample filling the optical cavity;

FIG. 10 is a top perspective view of the optical chamber device of FIG. 6, shown in use with a syringe and a diagnostic device; and

FIG. 11 is a schematic view of the cartridge assembly of FIG. 7, shown in use with a syringe, a light source, and photodetectors.

### DETAILED DESCRIPTION OF PREFERRED EMBODIMENTS

This disclosure, including the accompanying drawings, may include text, instructions, and/or dimensions and/or depictions of the invention which may or may not be provided to scale and, in any event, are provided by way of example. It may bear repeating, in this respect specifically, that such drawings and/or disclosures are for the purpose of illustration and description only, and not intended as a definition of the limits of the invention.

Additionally, one or more of the directional terms (e.g., top, bottom, middle, upper, lower, outer, inner, left, right, side, front, back) or other terms used herein, and in the accompanying drawings, may be otherwise regarded and/or referenced using other terms.

The method used to achieve short and consistent path lengths is to create two components of precise geometry that when placed in contact form a cavity of precise depth equal to the path length, and to bond these components together in a way that does not require tight process control to prevent distortions of the cavity.

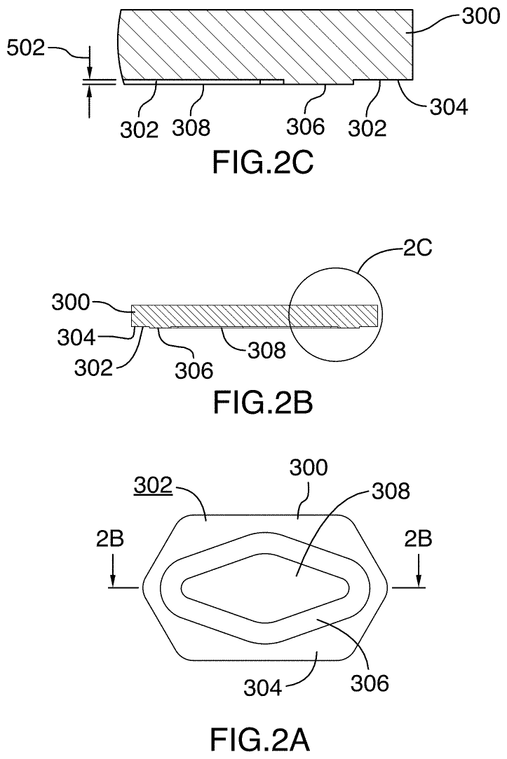

A first component, named the top plate 300, (best seen in FIGS. 2A to 2C) is preferably made from an optically transparent material appropriate for the application. Preferably, it features a lip member 306 on its bottom surface 302 which is offset from an outer portion 304. The inner portion 308 preferably forms part of the optical cavity (alternately herein, the “chamber”) 500, while the outer portion 304 preferably provides one half of the bonding area 514—i.e., alternately herein, the “interface” 514 of the two components 300, 400.

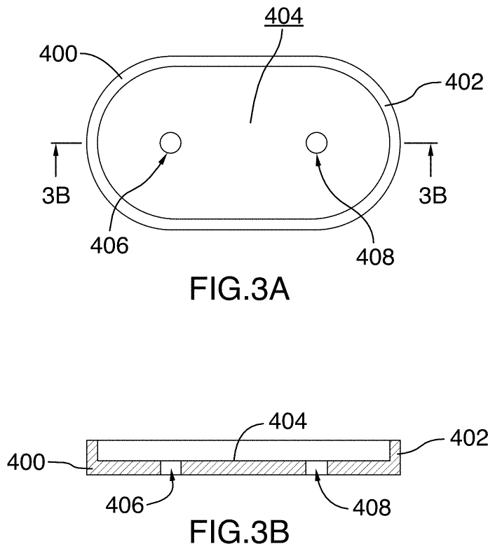

A second component, named the bottom plate 400, (best seen in FIGS. 3A and 3B) is preferably also made from an optically transparent material. Preferably, it has a flat top surface 404 with two through holes, an inlet hole 406 and an outlet hole 408, through which the sample 20 preferably flows into and out from the chamber 500 respectively.

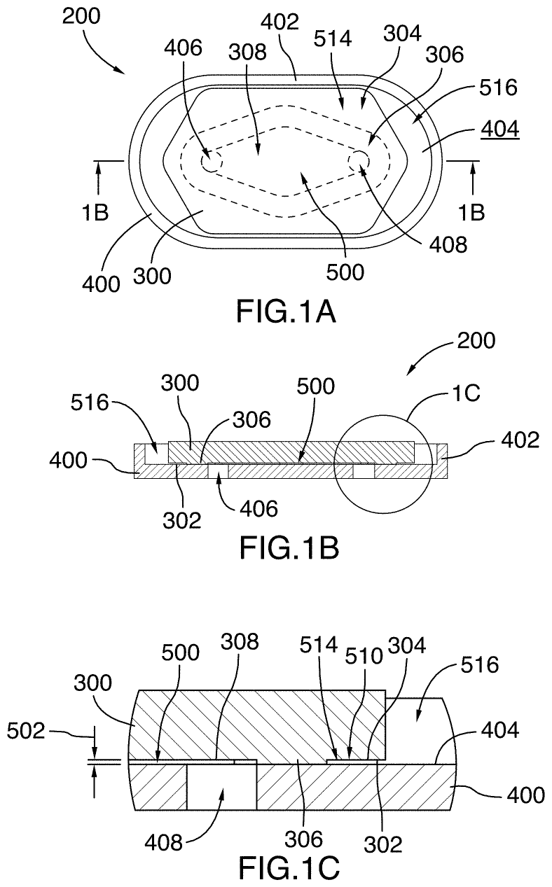

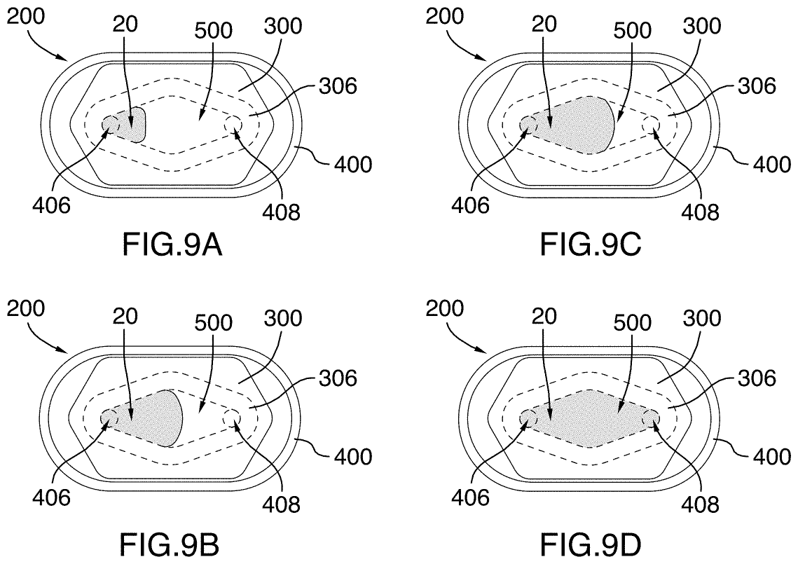

Preferably, when the top plate 300 is placed face down on the bottom plate 400, two geometrical features are formed as shown in FIGS. 1A to 1C. Firstly, the volume now bounded by the bottom surface 302 of the top plate 300, by the lip member 306 of the top plate 300, and by the top surface 404 of the bottom plate 400 is preferably the optical cavity 500. The optical cavity 500 can be filled with the sample 20, as shown in FIGS. 9A to 9D, preferably by means of the inlet hole 406 on the bottom plate 400.

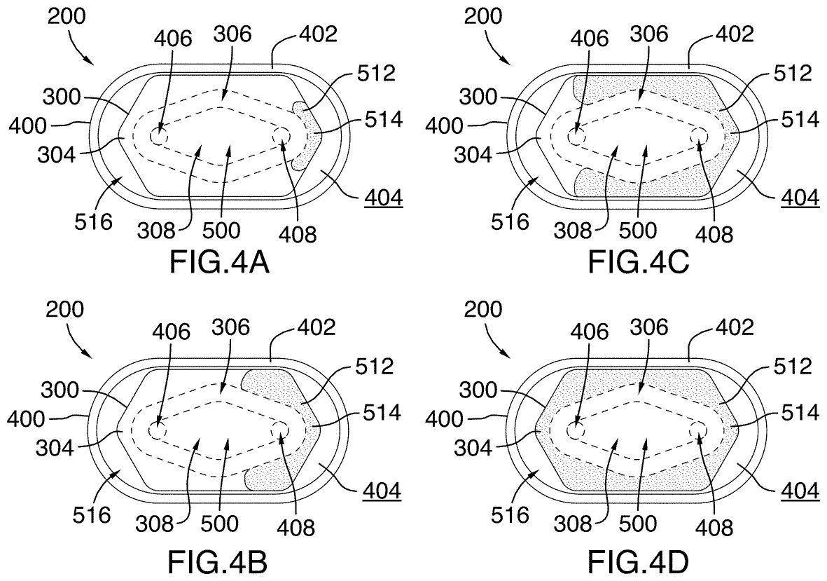

Secondly, an open groove 510 has also preferably formed around the perimeter of the interface 514 of the two components 300, 400, substantially adjacent to the outer portion 304 of the top plate 300. The geometry of this groove 510 is preferably such that when a liquid adhesive 512 is dispensed (preferably at any point) along the groove 510, the adhesive 512 will preferably wick around the interface 514, by capillary action, filling the bond area 514 (as shown in FIGS. 4A to 4D).

The adhesive 512 is preferably then cured by the appropriate method, to bond the components 300, 400 together and seal the optical cavity 500 around adjacent to the lip member 306. Any excess adhesive 512 will preferably pool in an open cavity 516 surrounding the bonding area 514 and bounded by a perimeter lip 402 of the bottom plate 400.

This method is preferably advantageous for at least a few reasons. First, the distance between the lip member 306 and the bottom surface 302 of the top plate 300 preferably represents a precise path length 502. This distance, also known as the path length, 502 preferably can be tightly controlled by producing this part 300 by injection moulding.

Additionally, a mould (not shown) used to produce this part 300 can preferably feature a core pin (not shown), preferably removable from the mould, whose height and flatness can preferably be precisely manufactured and/or inspected. Preferably in this way, the core pin can be replaced when out of spec, preferably without machining a new mould.

Preferably with this method, many different plastics can be used to form these components 300, 400, preferably so long as the optical properties fit with the application and/or they allow the adhesive 512 to wick effectively, given the geometry. If needed, additional chemical treatment of the surfaces 302, 404 can preferably be applied, such as ionizing plasma treatment, preferably to alter the surface properties and/or to promote capillary wicking.

Second, the adhesive 512 application and bonding process is preferably non-contact and preferably therefore does not introduce geometric distortions due to non-uniform force application or constrained expansion or contraction of the adhesive 512. This process is preferably flexible in allowing various adhesives 512 and methods of curing, preferably as long as wicking of the adhesive 512 and/or non-contact curing is preferably achieved. For example, a UV sensitive adhesive 512 could be used, which would be cured by a UV light in just a few seconds. Some pressure may be required to hold the components 300, 400 in contact during bonding. However the cavity 500 is preferably not sensitive to this pressure. Additional curing methods appropriate for a particular adhesive 512 may include thermal, humidity, catalyst or oxygen enhanced curing.

As described elsewhere herein, the perimeter lip 402 can preferably be formed on the bottom plate 400. The perimeter lip 402 preferably catches any excess adhesive 512 that is dispensed. This feature preferably helps to ensure a good seal 514 without requiring precise control of the dispensed adhesive 512 volume. Last, the adhesive 512 is preferably free to expand or contract during curing, preferably reducing the chances that stresses due to constrained adhesive 512 may distort the geometry of the optical cavity 500.

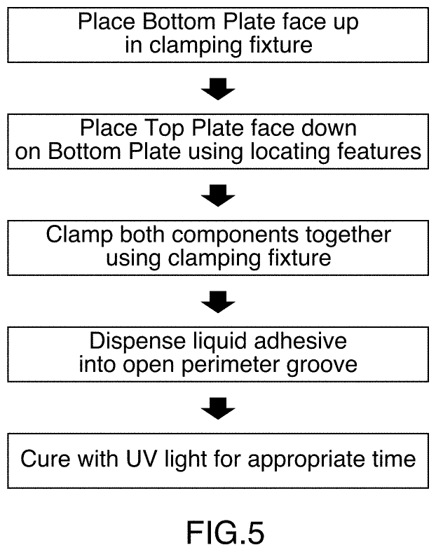

FIG. 5 captures preferable assembly process steps, illustrating the simplicity of this method for producing an optical cavity.

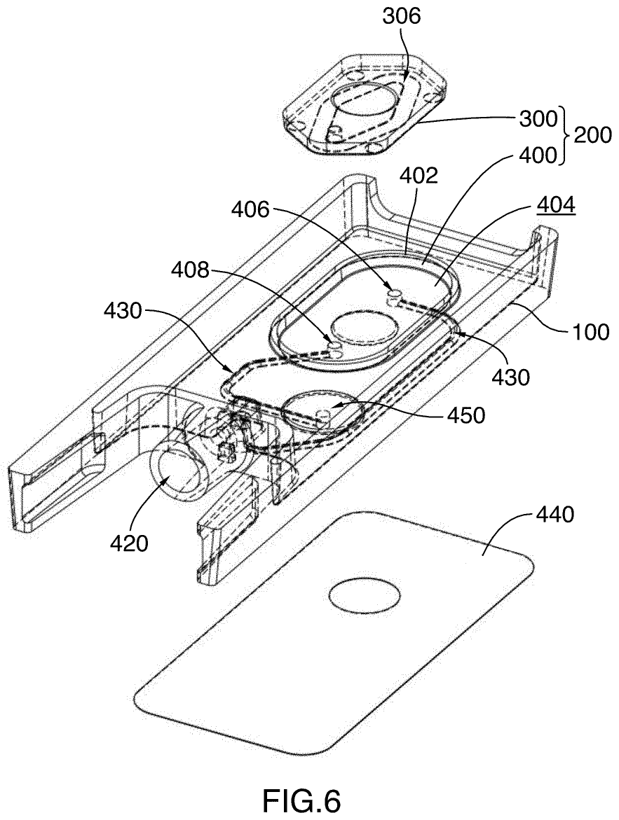

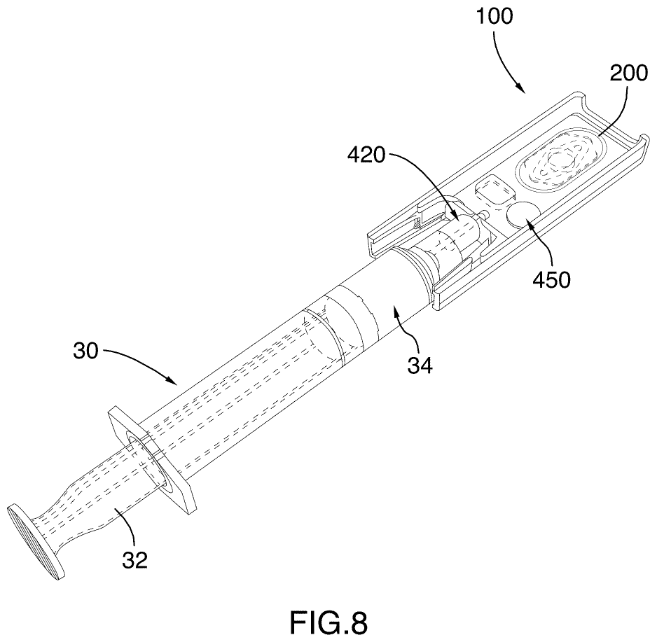

One preferred embodiment of the present invention is depicted in FIGS. 6 and 8, where the bottom plate 400 preferably has additional features, including a port 420 to accept a fluid sample 20 and fluidic channels 430 to transport the sample 20 to the optical cavity 500. A vent hole 450 is preferably provided to enable escape of any air in the cartridge 100 and to facilitate flow of the sample 20 within the fluidic channels 430. As shown in FIG. 6, a bottom single-sided adhesive label 440 preferably can be used to seal the fluidic channels 430.

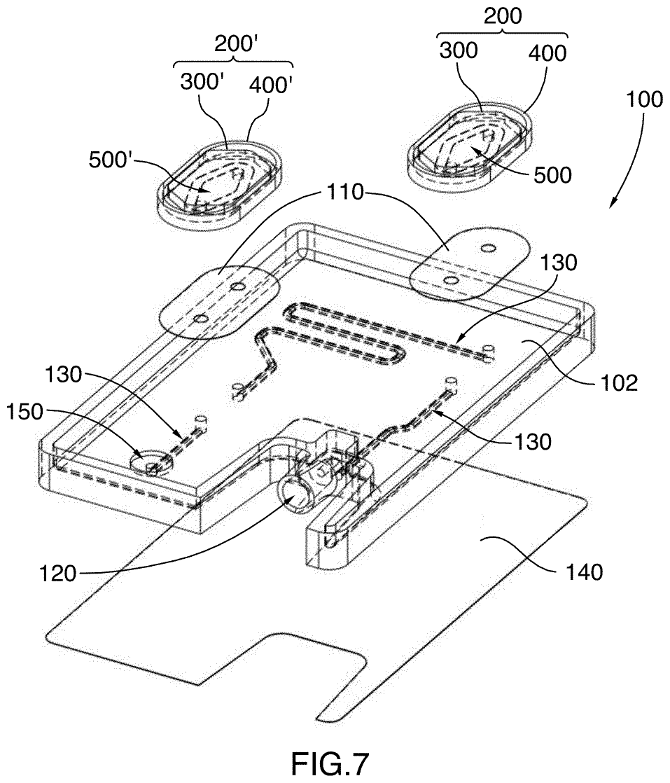

Another preferred embodiment is shown in FIG. 7, where two separate optical cavity sub-assemblies (or “modules”) 200, 200′ are preferably attached—preferably by a die cut double sided adhesive tape 110—to a diagnostic cartridge 100. This embodiment preferably includes a cartridge frame 102 which transports the sample 20 to the optical cavities 500, 500′ of the modules 200, 200′ via fluidic channels 130. The fluidic channels 130 are preferably sealed by a die-cut, single-sided adhesive label 140 placed on the bottom of the cartridge 100.

A flexibility afforded by various different embodiments, according to the invention, preferably makes the invention useful for diagnostic applications (a) where only one spectrophotometric measurement may be required, (b) where a diagnostic cartridge 100 makes multiple spectrophotometric measurements and/or other types of measurements—e.g., for potential use with a blood gas analysis cartridge that additionally makes electrical measurements on the same blood sample. And/or, (c) where multiple optical chambers 500, 500′ may be required to perform different analyses.

For example, a first optical chamber module 200 and its top and bottom plates 300, 400 bounding its chamber 500 (and any base cartridge frame 102 and/or cartridge 100) may be constructed from a different material than the material of construction for a second optical chamber module 200′ and its top and bottom plates 300′, 400′ bounding its chamber 500′ (et cetera). Some applications may require optical chambers 500, 500′ with different optical transmission properties and therefore may need to be made from different materials. For example, an analysis may be done in the UV range of wavelengths, requiring a first optical chamber device 200 having a first chamber 500 bounded by its top and bottom plates 300, 400 constructed of a material with appropriate transmission characteristics, and on the same cartridge 100, another analysis is done in the mid-IR requiring a second optical chamber device 200′ having a second chamber 500′ bounded by its top and bottom plates 300′, 400′ constructed of a separate compatible material.

The utility of the precise optical chamber 500, 500′ is preferably not limited spectrophotometric measurements, but may include utilities in association with many other optical techniques including, for example, image cytometry to count particles or biological cells, where chamber volume may need to be precisely controlled to achieve accurate concentration measurements.

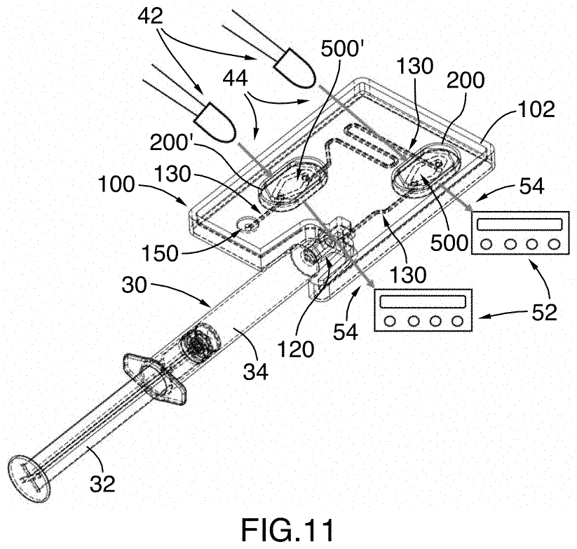

Preferably, a method of using the multi-measurement diagnostic cartridge 100 (shown schematically in FIG. 11) follows standard procedures found in the diagnostic field. A syringe 30 is preferably filled with a sample 20 of interest, such as whole blood. The syringe 30 is preferably attached to the cartridge 100 via a standard luer port 120 on the cartridge 100. A depressing action on a plunger 32 of the syringe 30 preferably forces the sample 20, out from a reservoir 34 within the plunger, through the port 120 and fluidic channels 130, and up through the inlet port 406 of the optical chamber device 200 into the optical cavity 500. Excess sample 20 preferably leaves the cavity 500 via the exit port 408, preferably enabled by a vent hole 150 at the termination of the channel 130 that allows air in the cartridge 100 to evacuate.

FIG. 11 shows this sequence happening twice consecutively, with the option of further re-direction of the sample 20 into cavities of different geometry where other types of sensors can preferably interrogate the sample 20. A light source 42 preferably emits light of a known spectrum 44 that passes through the sample 20 in the optical cavities 500, 500′. Preferably, the known spectrum 44 of light then becomes partially absorbed and scattered resulting in the photodetector 52 receiving a modified spectrum 54 of light. The differences between the input and output spectrums 44, 54 are preferably used to calculate the chemical composition of the sample 20.

According to preferred embodiments, the invention preferably provides for standalone CO-oximetry—e.g., oxyhemoglobin (O2Hb), de-oxyhemoglobin (HHb), methemoglobin (MetHb), carboxyhemoglobin (COHb), total hemoglobin (tHb)— to complement point-of-care blood gas analyzers, preferably for the complete assessment of oxygen status.

A complete set of CO-oximetry measurements preferably includes the following measured parameters: oxyhemoglobin (O2Hb); de-oxyhemoglobin (HHb); methemoglobin (MetHb); carboxyhemoglobin (COHb); and/or total hemoglobin (tHb).

A complete set of CO-oximetry calculated parameters preferably includes the following: hematocrit (Hct); oxygen content (O2Ct); percent saturation (SO2); and/or oxygen carrying capacity (O2Cap).

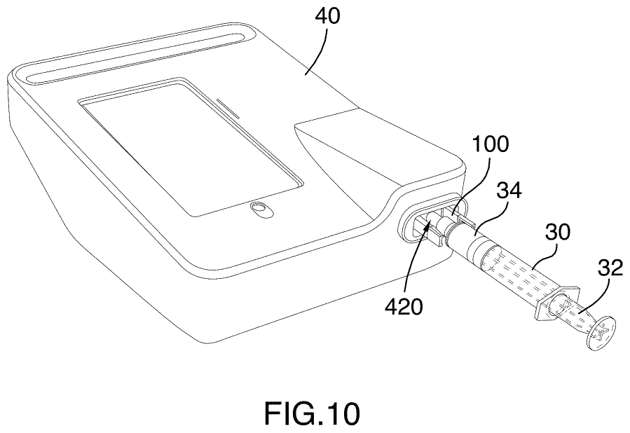

Preferably, the invention provides for an easy-to-use diagnostic device 40 (e.g., as shown in FIG. 10)— one that is preferably: a compact portable device; with rapid time to results; is battery operated; requiring little or no maintenance; and/or affords cloud connectivity.

It preferably works with and/or provides for simple, single-use cartridges 100. The sample cartridges 100 are preferably designed for low cost, high volume manufacturing, and/or featuring: small sample volume (40 μL); no sample preparation; easy sample 20 delivery from syringe 30; and/or long cartridge 100 shelf-life with room temperature storage.

According to preferred embodiments, the invention preferably provides an accurate and robust technology and/or for continuous-spectrum optical measurement at the point of care. It preferably provides CO-Oximetery that is designed for the point of care. It preferably involves a state-of-the-art CO-oximetry method that has been developed, according to the invention, for the point-of-care testing environment. The core technology can preferably be used in a stand-alone instrument, or integrated with existing blood gas instrumentation.

Preferred embodiments preferably have a robust design involving: a compact system and components; a solid-state, full-spectrum optical detection system, preferably with no moving parts; a simple, direct measurement method, preferably without hemolysis; a design adapted for stable, factory calibration, preferably with no user calibration required; and/or little or no maintenance. It preferably provides accurate and reliable results.

A number of primary clinical applications may be contemplated according to the invention, without limitation, including: (1) critical care applications, affording complete oxygenation status evaluation, and/or accurate total hemoglobin (and/or calculated hematocrit) to aid transfusion decisions; (2) NICU applications, preferably assessing methemoglobinemia; (3) emergency department applications, preferably for example for detection of carbon monoxide poisoning; and/or (4) cardiac catheterization lab applications, affording utilities for atrial septal defects, ventricular septal defects, and/or blood vessel shunts.

The devices, systems, and methods according to the invention preferably afford one or more advantages, including ease of use and/or fast time to results.

The devices, systems, and methods according to the invention preferably provide a state-of-the-art, point-of-care CO-Oximeter. In some preferred embodiments, this compact POCT instrument preferably directly measures five CO-oximetry components from unprocessed whole blood. The system preferably uses optics and/or data analysis technology. These technologies preferably enable direct measurement of unprocessed whole blood, preferably without the need for red blood cell hemolysis as found in some prior art benchtop systems. Preferred embodiments preferably feature a compact optical system, single-use sample cartridges and/or cloud connectivity. Cartridges are preferably adapted for mass manufacturing, have a long shelf-life, and/or can be stored at room temperature. Operation is preferably quick and simple.

Preferred embodiments of the invention preferably may complement bedside and/or near-patient blood gas analyzers without CO-OX capabilities. CO-oximetry measurements may be crucial in critical care settings, such as, for example, the intensive care unit, cardiac care unit, neonatal intensive care unit, emergency department, and/or emergency medical services. In addition to providing hemoglobin fractions, the accurate total hemoglobin (and calculated hematocrit) can facilitate transfusion decisions where POCT blood gas instruments may provide only unreliable conductometric hematocrit measurements.

The devices, systems, and methods according to the invention preferably provide a stand-alone POCT CO-oximeter. The small size of the device preferably integrates CO-Oximetry technologies with blood gas instrumentation. This preferably supports incorporation of CO-oximetry technology into one or more prior art blood gas platforms that may have previously lacked CO-oximetry.

Preferred embodiments of the invention may afford advantageous utilities in association with existing medical devices, as well as emerging blood gas and/or POCT devices.

The invention is contemplated for use in association with the diagnostic and/or point of care devices and/or to afford increased advantageous utilities in association with same. The invention, however, is not so limited. Other embodiments, which fall within the scope of the invention, may be provided.

The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components for others, with alternate configurations of components, etc). Although some of the components, relations, configurations and/or steps according to the invention are not specifically referenced in association with one another, they may be used, and/or adapted for use, in association therewith. For example, features may be discussed herein in the context of the device, which clearly could be recast as steps of a method and/or as the interworking of a system. All of the aforementioned and various other features, steps, interworkings, structures, configurations, relationships, utilities, and/or the like (any of which may be depicted and/or based hereon) may be, but are not necessarily, incorporated into and/or achieved by the invention. Any one or more of the aforementioned features, steps, interworkings, structures, configurations, relationships, utilities and the like may be implemented in and/or by the invention, on their own, and/or without reference, regard or likewise implementation of any of the other aforementioned features, steps, interworkings, structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims hereof.

1. A method of manufacturing an optical chamber device, for receiving a fluid sample and for use with an optical diagnostic device, the method comprising the steps of:
forming a transparent top plate with a bottom surface having an inner portion and an outer portion, and forming the transparent top plate with a downward-facing lip member that is inset from the outer portion and extends downwardly from the bottom surface by a precise depth, such that the inner portion is circumscribed by the downward-facing lip member;
forming a transparent bottom plate with a top surface;
placing the transparent top plate on the transparent bottom plate, with the downward-facing lip member engaging the top surface;
wherein an optical cavity is formed between the top surface and the inner portion on the bottom surface; wherein the optical cavity is bounded by the downward-facing lip member, such that the precise depth defines an optical path length for the optical cavity; and
wherein an open groove is formed between the top surface and the outer portion on the bottom surface, with the open groove extending about a perimeter of the downward-facing lip member;
dispensing a liquid adhesive into the open groove, such that the liquid adhesive wicks around the perimeter by capillary action and fills the open groove; and
curing the liquid adhesive to bond the transparent top plate together with the transparent bottom plate, and to seal the optical cavity around the perimeter;
whereby the optical path length of the optical cavity, that receives the liquid sample in use, is precisely controlled so that the optical diagnostic device can selectively perform precise optical measurements on the liquid sample in use.

2. A method according to claim 1, wherein the transparent top plate is formed by injection moulding.

3. A method according to claim 1, wherein the transparent bottom plate is formed, by injection moulding, with an upward-facing peripheral lip member that extends upwardly from the top surface; wherein when the transparent top plate is placed on the transparent bottom plate, the transparent top plate is placed within the upward-facing peripheral lip member on the top surface; and wherein when an excess of the liquid adhesive is dispensed into the open groove, the upward-facing peripheral lip member contains the excess.

4. A method according to claim 1, wherein the transparent top plate and the transparent bottom plate are formed from an optically transparent material that is appropriate for the precise optical measurements and the optical diagnostic device, and is selected from the group consisting of ultraviolet transparent materials, one or more color transparent materials, and infrared transparent materials.

5. A method according to claim 1, wherein the transparent bottom plate is integrally formed as part of a cartridge that, in use, receives the liquid sample and fills the optical cavity with the liquid sample, so that the optical diagnostic device can selectively perform the precise optical measurements on the liquid sample.

6. A method according to claim 1, further comprising a step of bonding the transparent top plate and the transparent bottom plate to a cartridge frame that, in use, receives the liquid sample and fills the optical cavity with the liquid sample, so that the optical diagnostic device can selectively perform the precise optical measurements on the liquid sample.

7. An optical chamber device manufactured according to the method of claim 1.

8. An optical chamber device, for receiving a fluid sample and for use with an optical diagnostic device, the device comprising:
a transparent bottom plate having a top surface; and
a transparent top plate having a bottom surface with an inner portion and an outer portion, and having a downward-facing lip member that is inset from the outer portion and extends downwardly from the bottom surface by a precise depth, such that the inner portion is circumscribed by the downward-facing lip member; wherein the downward-facing lip member engages the top surface;
wherein an optical cavity is formed between the top surface and the inner portion on the bottom surface; wherein the optical cavity is bounded by the downward-facing lip member, such that the precise depth defines an optical path length for the optical cavity; and
wherein an open groove is formed between the top surface and the outer portion on the bottom surface, with the open groove extending about a perimeter of the downward-facing lip member; and
wherein a cured liquid adhesive fills the open groove and bonds the transparent top plate together with the transparent bottom plate, and seals the optical cavity around the perimeter;
whereby the optical path length of the optical cavity, that receives the liquid sample in use, is precisely predetermined so that the optical diagnostic device can selectively perform precise optical measurements on the liquid sample in use.

9. A device according to claim 8, wherein the transparent bottom plate has an upward-facing peripheral lip member that extends upwardly from the top surface; wherein the transparent top plate is positioned within the upward-facing peripheral lip member on the top surface; and wherein the upward-facing peripheral lip member contains any excess of the cured liquid adhesive that is dispensed into the open groove.

10. A device according to claim 8, wherein the transparent top plate and the transparent bottom plate are constructed from an optically transparent material that is appropriate for the precise optical measurements and the optical diagnostic device, and is selected from the group consisting of ultraviolet transparent materials, one or more color transparent materials, and infrared transparent materials.

11. A device according to claim 8, further comprising a cartridge that, in use, receives the liquid sample and fills the optical cavity with the liquid sample, so that the optical diagnostic device can selectively perform the precise optical measurements on the liquid sample; and wherein the transparent bottom plate is integrally formed with the cartridge.

12. A device according to claim 8, further comprising a cartridge frame that, in use, receives the liquid sample and fills the optical cavity with the liquid sample, so that the optical diagnostic device can selectively perform the precise optical measurements on the liquid sample; and wherein the transparent top plate and the transparent bottom plate are bonded to the cartridge frame.
